(19) United States
(12) Patent Application Publication
(10) Pub. No.: US 2026/0126326 A1
(43) Pub. Date: May 7, 2026

(54) BATTERY SYSTEM AND BATTERY POWER CONTROL METHOD BASED ON BATTERY TEMPERATURE SENSOR LAYOUT

(71) Applicants: HYUNDAI MOTOR COMPANY, Seoul (KR); Kia Corporation, Seoul (KR)

(72) Inventors: Zhenghui LI, Shandong (CN); Wen Na SHI, Shandong (CN); Ling GUO, Shandong (CN); Hongli FU, Shandong (CN)

(73) Assignees: HYUNDAI MOTOR COMPANY, Seoul (KR); Kia Corporation, Seoul (KR)

(21) Appl. No.: 19/381,179

(22) Filed: Nov. 6, 2025

(30) Foreign Application Priority Data
Nov. 6, 2024 (CN) 202411577696.4

(51) Int. Cl. G01K 3/00; G01K 1/02; H01M 10/48

(52) U.S. Cl. CPC G01K 3/005; G01K 1/026; H01M 10/482; H01M 10/486

(57) ABSTRACT

A battery system based on a battery temperature sensor layout in which a battery includes a plurality of cells and a cooling block disposed at an upper side of the cell includes: at least one first temperature sensor that is disposed adjacent to an explosion-proof valve of the at least one cell and is configured to sense a temperature of the cell; at least one second temperature sensor that is disposed at a lower portion of the at least one cell and is configured to sense a temperature of the cell; at least one third temperature sensor that is disposed at an upper portion of the at least one cell and is configured to sense a temperature of the cell; and a controller that is configured to receive temperatures sensed by the first temperature sensor, the second temperature sensor, and the third temperature sensor and to determine whether a thermal runaway fault, an over-temperature fault, or a low temperature fault of the battery occurs based on the temperatures sensed by the first temperature sensor, the second temperature sensor, and the third temperature sensor.

### CROSS-REFERENCE TO RELATED APPLICATIONS

This application claims priority to and the benefit of Chinese Patent Application No. 202411577696.4 filed with the Chinese National Intellectual Property Administration on Nov. 6, 2024, the entire contents of which are incorporated herein by reference in its entirety.

### FIELD

The present disclosure relates to a battery system and a method for controlling battery power based on a battery temperature sensor layout.

### BACKGROUND

Electric vehicle battery systems consist of numerous individual cells, and maintaining optimal temperature across these cells is essential for ensuring performance, safety, and longevity. Temperature fluctuations can lead to cell degradation, reduced efficiency, and even safety hazards such as thermal runaway.

Conventional temperature monitoring approaches often involve placing sensors inside individual cells. While this provides accurate localized data, it is not scalable for large battery systems due to increased cost, complexity, and manufacturing challenges. Moreover, selectively placing sensors in only a few cells can result in inconsistent thermal data, making it difficult to assess the overall health of the battery system reliably.

Therefore, there is a need for a more practical solution that enables consistent and comprehensive temperature monitoring across the battery system.

### SUMMARY

An embodiment of the present disclosure may sense temperatures of different portions outside a cell by disposing temperature sensors at different portions outside the cell, and may control power of a battery by determining whether a fault of the battery occurs and a type of the fault according to the sensed temperatures. Therefore, a battery system and a battery power control method capable of improving life and safety of the battery are provided.

According to an embodiment of the present disclosure, a battery system based on a battery temperature sensor layout is provided. The battery system in which a battery includes a plurality of cells and a cooling block disposed at an upper side of the cell includes: at least one first temperature sensor that is disposed adjacent to an explosion-proof valve of the at least one cell and is configured to sense a temperature of the cell; at least one second temperature sensor that is disposed at a lower portion of the at least one cell and is configured to sense a temperature of the cell; at least one third temperature sensor that is disposed at an upper portion of the at least one cell and is configured to sense a temperature of the cell; and a controller that is configured to receive temperatures sensed by the first temperature sensor, the second temperature sensor, and the third temperature sensor and to determine whether a thermal runaway fault, an over-temperature fault, or a low temperature fault of the battery occurs based on the temperatures sensed by the first temperature sensor, the second temperature sensor, and the third temperature sensor.

The controller may be configured to: determine a maximum temperature and a minimum temperature based on the temperatures sensed by the first temperature sensor, the second temperature sensor, and the third temperature sensor, and determine whether the thermal runaway fault, the over-temperature fault, or the low temperature fault of the battery occurs using the determined maximum and minimum temperatures.

The controller may be further configured to: set charging power or discharging power of the battery to zero based on determining that the thermal runaway fault, the over-temperature fault, or the low temperature fault occurs in the battery, a charging voltage of the battery reaches a charging cutoff voltage, or a discharging voltage of the battery reaches a discharging cutoff voltage, and determine maximum charging power or maximum discharging power of the battery and make power of the battery less than or equal to the maximum charging power or the maximum discharging power based on determining that the thermal runaway fault not occurring, the over-temperature fault not occurring, the low temperature fault not occurring, the charging voltage of the battery not reaching the charging cutoff voltage, and the discharging voltage of the battery not reaching the discharging cutoff voltage.

The controller may be further configured to: determine whether the maximum temperature exceeds a first predetermined temperature and maintains for a first predetermined time, and determine that the thermal runaway fault occurs based on the maximum temperature exceeding the first predetermined temperature and maintaining for the first predetermined time.

The controller may be further configured to: determine whether the maximum temperature exceeds a second predetermined temperature and maintains for a second predetermined time and whether one-third or more of a total number of the first temperature sensor, the second temperature sensor, and the third temperature sensor are disconnected and disconnected states continue for the second predetermined time based on the maximum temperature not exceeding the first predetermined temperature or a state in which the maximum temperature exceeds the first predetermined temperature not maintaining for the first predetermined time, and determine that the thermal runaway fault occurs based on the maximum temperature exceeding the second predetermined temperature and maintaining for the second predetermined time and the one-third or more of the total number of the first temperature sensor, the second temperature sensor, and the third temperature sensor being disconnected and the disconnected states continuing for the second predetermined time, wherein the second predetermined temperature is less than the first predetermined temperature.

The controller may be further configured to: determine whether the maximum temperature exceeds the second predetermined temperature and whether the temperatures continuously rise within a third predetermined time so that a predetermined temperature difference between the temperatures occurs based on the maximum temperature not exceeding the second predetermined temperature, a state in which the maximum temperature exceeds the second predetermined temperature not continuing for the second predetermined time, the one-third or more of the total number of the first temperature sensor, the second temperature sensor, and the third temperature sensor not being disconnected, or a state in which the one-third or more of the total number of the first temperature sensor, the second temperature sensor, and the third temperature sensor are disconnected not continuing for the second predetermined time, and determine that the thermal runaway fault occurs based on the maximum temperature exceeding the second predetermined temperature and the temperature continuously rising within the third predetermined time so that the predetermined temperature difference between the temperatures occurs.

The controller may be further configured to: determine whether the maximum temperature is less than a third predetermined temperature based on the maximum temperature not exceeding the second predetermined temperature, the temperature not continuously rising within the third predetermined time, or the predetermined temperature difference between the temperatures not occurring, and determine that the thermal runaway fault does not occur based on the maximum temperature being less than the third predetermined temperature, wherein the third predetermined temperature is less than the second predetermined temperature.

The controller may be further configured to: determine whether the maximum temperature exceeds the second predetermined temperature based on the maximum temperature exceeding the third predetermined temperature, determine again whether the maximum temperature continuously rises within the third predetermined time so that the predetermined temperature difference between the temperatures occurs after a fourth predetermined time based on the maximum temperature exceeding the second predetermined temperature, and determine that the thermal runaway fault does not occur based on the maximum temperature not exceeding the second predetermined temperature.

The controller may be further configured to: determine whether the minimum temperature is less than a fourth predetermined temperature, and determine that the low temperature fault occurs based on the minimum temperature being less than the fourth predetermined temperature.

The controller may be further configured to: determine whether the maximum temperature exceeds a fifth predetermined temperature based on the minimum temperature not being less than the fourth predetermined temperature, and determine that the over-temperature fault occurs based on the maximum temperature exceeding the fifth predetermined temperature, wherein the fifth predetermined temperature is greater than the fourth predetermined temperature.

The controller may be further configured to: determine whether the maximum temperature exceeds a sixth predetermined temperature based on the maximum temperature not exceeding the fifth predetermined temperature, and set charging power of the battery to 0 or determine maximum discharging power of the battery and set power of the battery to be less than or equal to the maximum discharging power based on the maximum temperature exceeding the sixth predetermined temperature, wherein the sixth predetermined temperature is less than the fifth predetermined temperature.

The controller may be further configured to: determine charging power at the maximum temperature of the battery and charging power at the minimum temperature of the battery based on the maximum temperature, the minimum temperature, and a state of charge (SOC) of the battery, and determine a smaller power among the charging power at the maximum temperature and the charging power at the minimum temperature as maximum charging power of the battery based on the battery being charged; and determine discharging power at the maximum temperature of the battery and discharging power at the minimum temperature of the battery based on the maximum temperature, the minimum temperature, and the SOC of the battery, and determine a smaller power among the discharging power at the maximum temperature and the discharging power at the minimum temperature as maximum discharging power of the battery based on the battery being discharged.

According to an embodiment of the present disclosure, a power control method of a battery that includes a plurality of cells and a cooling block disposed at an upper side of the cell is provided. The power control method includes: sensing temperatures of the cell using at least one first temperature sensor, at least one second temperature sensor, and at least one third temperature sensor; and determining whether a thermal runaway fault, an over-temperature fault, or a low temperature fault of the battery occurs using the temperatures sensed by the first temperature sensor, the second temperature sensor, and the third temperature sensor. The at least one first temperature sensor is disposed adjacent to an explosion-proof valve of the at least one cell, the at least one second temperature sensor is disposed at a lower portion of the at least one cell, and the at least one third temperature sensor is disposed at an upper portion of the at least one cell.

The power control method may further include: determining a maximum temperature and a minimum temperature based on the temperatures sensed by the first temperature sensor, the second temperature sensor, and the third temperature sensor; and determining whether the thermal runaway fault, the over-temperature fault, or the low temperature fault of the battery occurs using the determined maximum and minimum temperatures.

The power control method may further include: setting charging power or discharging power of the battery to zero based on determining that the thermal runaway fault, the over-temperature fault, or the low temperature fault occurs in the battery, a charging voltage of the battery reaches a charging cutoff voltage, or a discharging voltage of the battery reaches a discharging cutoff voltage; and determining maximum charging power or maximum discharging power of the battery and making power of the battery less than or equal to the maximum charging power or the maximum discharging power based on determining that the thermal runaway fault does not occur, the over-temperature fault does not occur, the low temperature fault does not occur, the charging voltage of the battery does not reach the charging cutoff voltage, and the discharging voltage of the battery does not reach the discharging cutoff voltage.

The power control method may further include: determining whether the maximum temperature exceeds a first predetermined temperature and maintains for a first predetermined time; and determining that the thermal runaway fault occurs based on the maximum temperature exceeding the first predetermined temperature and maintaining for the first predetermined time.

The power control method may further include: determining whether the maximum temperature exceeds a second predetermined temperature and maintains for a second predetermined time and whether one-third or more of a total number of the first temperature sensor, the second temperature sensor, and the third temperature sensor are disconnected and disconnected states continue for the second predetermined time based on the maximum temperature not exceeding the first predetermined temperature or a state in which the maximum temperature exceeds the first predetermined temperature not maintaining for the first predetermined time; and determining that the thermal runaway fault occurs based on the maximum temperature exceeding the second predetermined temperature and maintaining for the second predetermined time and the one-third or more of the total number of the first temperature sensor, the second temperature sensor, and the third temperature sensor being disconnected and the disconnected states continuing for the second predetermined time, wherein the second predetermined temperature is less than the first predetermined temperature.

The power control method may further include: determining whether the maximum temperature exceeds the second predetermined temperature and whether the temperatures continuously rise within a third predetermined time so that a predetermined temperature difference between the temperatures occurs based on the maximum temperature not exceeding the second predetermined temperature, a state in which the maximum temperature exceeds the second predetermined temperature not continuing for the second predetermined time, the one-third or more of the total number of the first temperature sensor, the second temperature sensor, and the third temperature sensor not being disconnected, or a state in which the one-third or more of the total number of the first temperature sensor, the second temperature sensor, and the third temperature sensor are disconnected not continuing for the second predetermined time; and determining that the thermal runaway fault occurs based on the maximum temperature exceeding the second predetermined temperature and the temperature continuously rising within the third predetermined time so that the predetermined temperature difference between the temperatures occurs.

The power control method may further include: determining whether the maximum temperature is less than a third predetermined temperature based on the maximum temperature not exceeding the second predetermined temperature, the temperature not continuously rising within the third predetermined time, or the predetermined temperature difference between the temperatures not occurring; and determining that the thermal runaway fault does not occur based on the maximum temperature being less than the third predetermined temperature, wherein the third predetermined temperature is less than the second predetermined temperature.

The power control method may further include: determining whether the maximum temperature exceeds the second predetermined temperature based on the maximum temperature exceeding the third predetermined temperature; determining again whether the maximum temperature continuously rises within the third predetermined time so that the predetermined temperature difference between the temperatures occurs after a fourth predetermined time based on the maximum temperature exceeding the second predetermined temperature; and determining that the thermal runaway fault does not occur based on the maximum temperature not exceeding the second predetermined temperature.

The power control method may further include: determining whether the minimum temperature is less than a fourth predetermined temperature; and determining that the low temperature fault occurs based on the minimum temperature being less than the fourth predetermined temperature.

The power control method may further include: determining whether the maximum temperature exceeds a fifth predetermined temperature based on the minimum temperature not being less than the fourth predetermined temperature; and determining that the over-temperature fault occurs based on the maximum temperature exceeding the fifth predetermined temperature, wherein the fifth predetermined temperature is greater than the fourth predetermined temperature.

The power control method may further include: determining whether the maximum temperature exceeds a sixth predetermined temperature based on the maximum temperature not exceeding the fifth predetermined temperature; and setting charging power of the battery to 0 or determining maximum discharging power of the battery and setting power of the battery to be less than or equal to the maximum discharging power based on the maximum temperature exceeding the sixth predetermined temperature, wherein the sixth predetermined temperature is less than the fifth predetermined temperature.

The power control method may further include: determining charging power at the maximum temperature of the battery and charging power at the minimum temperature of the battery based on the maximum temperature, the minimum temperature, and an SOC of the battery, and determining a smaller power among the charging power at the maximum temperature and the charging power at the minimum temperature as maximum charging power of the battery based on the battery being charged; and determining discharging power at the maximum temperature of the battery and discharging power at the minimum temperature of the battery based on the maximum temperature, the minimum temperature, and the SOC of the battery, and determining a smaller power among the discharging power at the maximum temperature and the discharging power at the minimum temperature as maximum discharging power of the battery based on the battery being discharged.

According to an embodiment of the present disclosure, temperature sensors may be disposed at different portions of a cell so that temperatures of different portions of the cell are sensed, the sensed temperatures may be used so that whether a fault of a battery occurs and a type of the fault, and power of the battery may be controlled so that life and safety of the battery are improved.

In addition, an effect obtained or predicted by an embodiment of the present disclosure is disclosed directly or implicitly in a detailed description of the present disclosure. That is, various effects predicted according to the present disclosure will be disclosed in the detailed description to be described below.

### BRIEF DESCRIPTION OF THE DRAWINGS

Hereinafter, an embodiment of the present disclosure will be described in more detail with reference to the drawings. For clarity, the same members in different drawings are denoted by the same reference numerals. It should be noted that the drawings are illustrative only and are not necessarily drawn to scale.

FIG. 1 is a schematic diagram of a battery system based on a battery temperature sensor layout according to an embodiment of the present disclosure.

FIG. 2 is a discharging power table of the battery system based on the battery temperature sensor layout according to an embodiment of the present disclosure.

FIG. 3A and FIG. 3B are flowcharts of a battery power control method according to an embodiment of the present disclosure.

### DETAILED DESCRIPTION

Hereinafter, an embodiment of the present disclosure will be described in detail, the present embodiment is implemented based on a technical solution of the present disclosure, and a detailed implementation method and a specific operation process are presented, but a protection scope of the present disclosure is not limited to an embodiment described below.

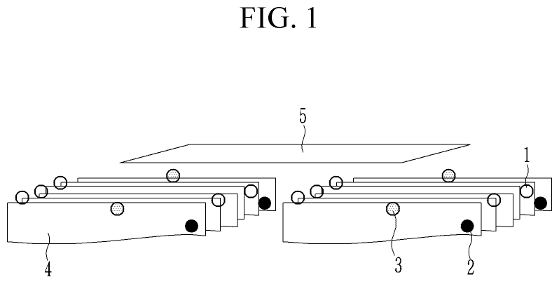

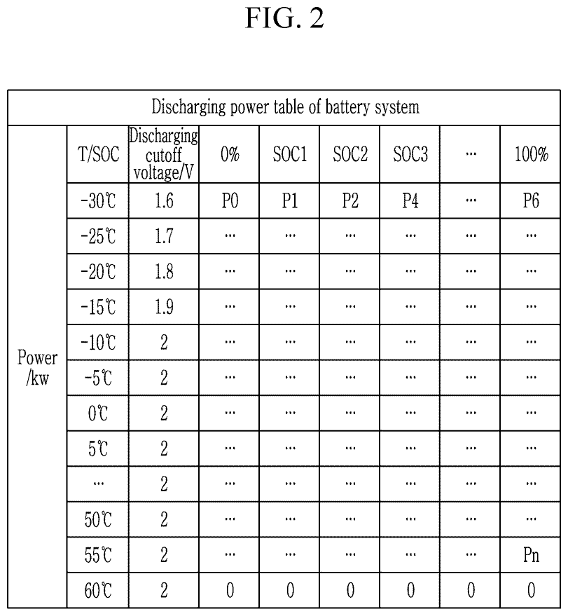

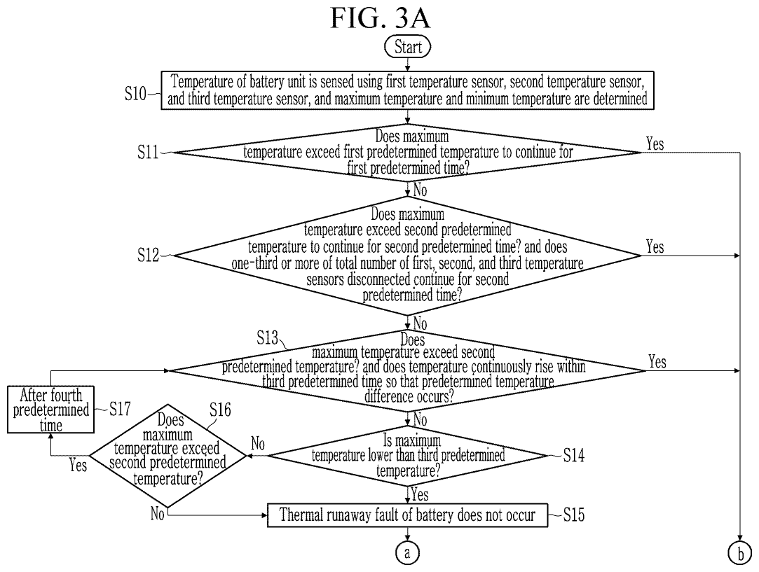

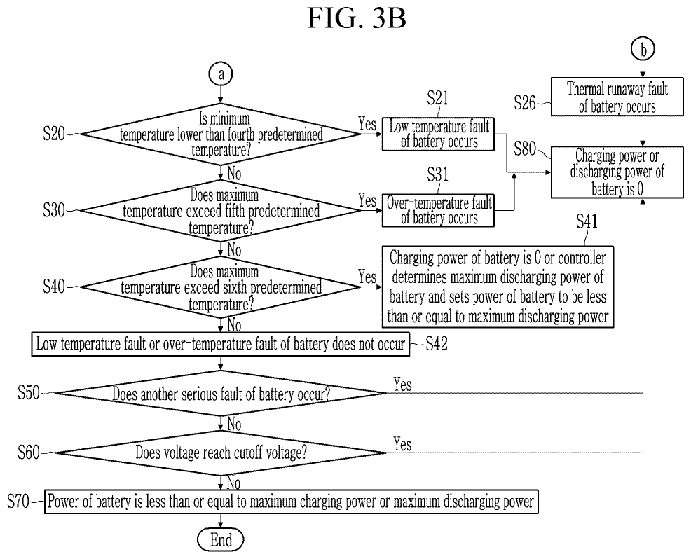

FIG. 1 is a schematic diagram of a battery system based on a battery temperature sensor layout according to an embodiment of the present disclosure, and FIG. 2 is a discharging power table of the battery system based on the battery temperature sensor layout according to an embodiment of the present disclosure. FIG. 3A and FIG. 3B are flowcharts of a battery power control method according to an embodiment of the present disclosure.

As shown in FIG. 1, the battery system based on the battery temperature sensor layout according to the embodiment of the present disclosure may include 124 cells 4. The cell 4 may have a blade-shaped structure, the cells 4 may be equally divided into two rows, and each row may include 62 cells 4. In the battery system based on the battery temperature sensor layout according to the embodiment of the present disclosure, a cooling block 5 for cooling a battery may be disposed at an upper side of all cells 4.

The battery system based on the battery temperature sensor layout according to the embodiment of the present disclosure may further include at least one first temperature sensor 1, at least one second temperature sensor 2, and at least one third temperature sensor 3. The battery system based on the battery temperature sensor layout according to the embodiment of the present disclosure may include ten first temperature sensors 1, four second temperature sensors 2, and four third temperature sensors 3.

Because the first temperature sensor 1 is disposed adjacent to an explosion-proof valve of the cell 4 and is used to sense a temperature of the cell 4, temperature abnormality of the cell 4 may be immediately identified. In the battery system based on the battery temperature sensor layout according to the embodiment of the present disclosure, each of two rows of cells 4 may include five first temperature sensors 1, three first temperature sensors 1 among the five first temperature sensors 1 may be disposed at a left side of the cell 4, and for example, the three first temperature sensors 1 may be uniformly disposed in a disposition direction of the cell 4. Two first temperature sensors 1 among the five first temperature sensors 1 may be disposed at a right side of the cell 4, and for example, the two first temperature sensors 1 may be uniformly disposed in a disposition direction of the cell 4.

Because the second temperature sensor 2 is disposed at a lower portion of the cell 4 and is used to sense a temperature of the cell 4, a minimum temperature of the cell 4 may be immediately identified during a low-temperature heating operation of the battery. Additionally, the second temperature sensor 2 may immediately determine a maximum temperature of the cell 4 during a cooling operation at a high temperature of the battery. In the battery system based on the battery temperature sensor layout according to the embodiment of the present disclosure, each of two rows of cells 4 may include two second temperature sensors 2. The two second temperature sensors 2 may be disposed at a lower right of the cell 4, and for example, the two second temperature sensors 2 may be disposed at a lower right of an outermost cell 4 in a disposition direction of the cell 4.

Because the third temperature sensor 3 is disposed at an upper portion of the cell 4 and is used to sense a temperature of the cell 4, a minimum temperature of the cell 4 may be immediately identified during a cooling operation when the battery is at a high temperature, and a maximum temperature of the cell may be immediately identified during a heating operation when the battery is at a low temperature. In the battery system based on the battery temperature sensor layout according to the embodiment of the present disclosure, each of two rows of cells 4 may include two third temperature sensors 3, and the two third temperature sensors 3 may be disposed at an upper-middle portion of the cell 4. For example, the third temperature sensor 3 may be disposed at an upper-middle portion of an outermost cell 4 in a disposition direction of the cell 4.

The battery system based on the battery temperature sensor layout according to the embodiment of the present disclosure may further include a controller. The controller may receive temperatures sensed by the first temperature sensor 1, the second temperature sensor 2, and the third temperature sensor 3, and may determine whether a thermal runaway fault, an over-temperature fault, or a low temperature fault of the battery occurs based on the temperatures sensed by the first temperature sensor 1, the second temperature sensor 2, and the third temperature sensor 3. If it is determined that the thermal runaway fault, the over-temperature fault, the low temperature fault, or another serious fault occurs in the battery, a charging voltage of the battery reaches a charging cutoff voltage, or a discharging voltage of the battery reaches a discharging cutoff voltage, the controller may set charging power or discharging power of the battery to zero. If it is determined that the thermal runaway fault does not occur, the over-temperature fault does not occur, the low temperature fault does not occur, and the other serious fault does not occur based on the temperatures sensed by the first temperature sensor 1, the second temperature sensor 2, and the third temperature sensor 3, the charging voltage of the battery does not reach the charging cutoff voltage, and the discharging voltage of the battery does not reach the discharging cutoff voltage, the controller may determine maximum charging power or maximum discharging power of the battery and may make power of the battery less than or equal to the maximum charging power or the maximum discharging power.

For example, the controller may be configured to compare the temperatures sensed by the first temperature sensor 1, the second temperature sensor 2, and the third temperature sensor 3 and determine a maximum temperature and a minimum temperature sensed.

After the maximum temperature and the minimum temperature are determined, the controller may determine whether the sensed maximum temperature exceeds a first predetermined temperature to continue for a first predetermined time. In an embodiment of the present disclosure, a normal use temperature range of the battery may be −30° C. to 60° C., the first predetermined temperature may be set to 90° C., and the first predetermined time may be 5 s. For example, when the temperatures sensed by the first temperature sensor 1, the second temperature sensor 2, and the third temperature sensor 3 are compared, a second high temperature sensed may be additionally determined as a next highest temperature, and the controller may secure accuracy by determining whether the maximum temperature and the next highest temperature among the sensed temperatures exceed the first predetermined temperature to continue for the first predetermined time.

If the sensed maximum temperature exceeds the first predetermined temperature to continue for the first predetermined time, the controller may determine that the thermal runaway fault of the battery occurs and may set charging power or discharging power of the battery to 0.

If the maximum temperature does not exceed the first predetermined temperature or a state in which the maximum temperature exceeds the first predetermined temperature does not continue for the first predetermined time, the controller may determine whether the maximum temperature exceeds a second predetermined temperature to continue for a second predetermined time and whether one-third or more of a total number of the first temperature sensor, the second temperature sensor, and the third temperature sensor disconnected continues for the second predetermined time. A ratio of the number of disconnected sensors to the total number of the first temperature sensor, the second temperature sensor, and the third temperature sensor may be set according to an actual usage situation. In an embodiment of the present disclosure, the second predetermined temperature may be set to 70° C., the second predetermined time may be 30 seconds, and if the total number of the first temperature sensor, the second temperature sensor, and the third temperature sensor is 18, the number of disconnected temperature sensors may be 7.

If the maximum temperature exceeds the second predetermined temperature to continue for the second predetermined time and the one-third or more of the total number of the first temperature sensor, the second temperature sensor, and the third temperature sensor disconnected continues for the second predetermined time, the controller may determine that the thermal runaway fault of the battery occurs and may set charging power or discharging power of the battery to 0.

If the maximum temperature does not exceed the second predetermined temperature, a state in which the maximum temperature exceeds the second predetermined temperature does not continue for the second predetermined time, the one-third or more of the total number of the first temperature sensor, the second temperature sensor, and the third temperature sensor are not disconnected, or a state in which the one-third or more of the total number of the first temperature sensor, the second temperature sensor, and the third temperature sensor are disconnected does not continue for the second predetermined time, the controller may determine whether the maximum temperature exceeds the second predetermined temperature and whether a temperature continuously rises within a third predetermined time so that a predetermined temperature difference occurs. In an embodiment of the present disclosure, the third predetermined time may be set to 60 seconds, and the predetermined temperature difference may be set to 20° C. For example, the maximum temperature may continuously rise within the third predetermined time, and the predetermined temperature difference may occur within the third predetermined time.

If the maximum temperature exceeds the second predetermined temperature and the temperature continuously rises within the third predetermined time so that the predetermined temperature difference occurs, the controller may determine that the thermal runaway fault of the battery occurs and may set the charging power or discharging power of the battery to 0.

If the maximum temperature does not exceed the second predetermined temperature, the temperature does not continuously rise within the third predetermined time, or the predetermined temperature difference does not occur, the controller may determine whether the maximum temperature is less than the third predetermined temperature. In an embodiment of the present disclosure, the third predetermined temperature may be set to 65° C.

If the maximum temperature is less than the third predetermined temperature, the controller may determine that the thermal runaway fault of the battery does not occur.

If the maximum temperature exceeds the third predetermined temperature, the controller may determine whether the maximum temperature exceeds the second predetermined temperature, and if the maximum temperature exceeds the second predetermined temperature, after a fourth predetermined time, the controller may determine again whether the maximum temperature continuously rises within the third predetermined time so that a predetermined temperature difference occurs. In an embodiment of the present disclosure, the fourth predetermined time may be 1 min.

If the maximum temperature does not exceed the second predetermined temperature, the controller may determine that the thermal runaway fault of the battery does not occur.

Additionally, if the controller determines that the thermal runaway fault of the battery does not occur, the controller may determine whether the minimum temperature is less than a fourth predetermined temperature. In an embodiment of the present disclosure, the fourth predetermined temperature may be set to −30° C.

If the minimum temperature is less than the fourth predetermined temperature, the controller may determine that the low temperature fault occurs and may set charging power or discharging power of the battery to 0.

If the minimum temperature is not less than the fourth predetermined temperature, the controller may determine whether the maximum temperature exceeds a fifth predetermined temperature. In an embodiment of the present disclosure, the fifth predetermined temperature may be set to 60° C.

If the maximum temperature exceeds the fifth predetermined temperature, the controller may determine that the over-temperature fault occurs and may set charging power or discharging power of the battery to 0.

If the maximum temperature does not exceed the fifth predetermined temperature, the controller may determine whether the maximum temperature exceeds a sixth predetermined temperature. In an embodiment of the present disclosure, the sixth predetermined temperature may be set to 55° C.

If the maximum temperature exceeds the sixth predetermined temperature, the controller may set charging power of the battery to 0, or the controller may determine maximum discharging power of the battery and may set power of the battery to be less than or equal to the maximum discharging power. A method of determining the maximum discharging power of the battery will be described below.

If the maximum temperature does not exceed the sixth predetermined temperature, the controller may determine that the low temperature fault or the over-temperature fault of the battery does not occur.

If the controller determines that the thermal runaway fault, the low temperature fault, and the over-temperature fault of the battery do not occur, the controller may determine whether another serious fault of the battery occurs based on fault alarm information or a flag generated by a battery controller. If a fault that seriously affects safety of the battery and a vehicle occurs in the battery system, the controller may set charging power or discharging power of the battery to zero. If it is determined that the other serious fault does not occur in the battery, the controller may determine whether the charging voltage of the battery reaches the charging cutoff voltage or whether the discharging voltage of the battery reaches the discharging cutoff voltage. If it is determined that the charging voltage of the battery reaches the charging cutoff voltage or the discharging voltage of the battery reaches the discharging cutoff voltage, the controller may set charging power or discharging power of the battery to 0.

If it is determined that the charging voltage of the battery does not reach the charging cutoff voltage and the discharging voltage of the battery does not reach the discharging cutoff voltage, the controller may determine maximum charging power or maximum discharging power of the battery, and may make power of the battery less than or equal to the maximum charging power or the maximum discharging power.

As shown in FIG. 2, if the battery is discharged, the controller may inquire about a discharging power table to determine discharging power at the maximum temperature of the battery and discharging power at the minimum temperature of the battery using the maximum temperature, the minimum temperature, and an SOC of the battery that are determined, and may compare the determined discharging powers with each other to determine small discharging power as maximum discharging power of the battery.

Similarly, if the battery is charged, the controller may inquire about a charging power table to determine charging power at the maximum temperature of the battery and charging power at the minimum temperature of the battery using the maximum temperature, the minimum temperature, and an SOC of the battery that are determined, and may compare the determined charging powers to determine small charging power as maximum charging power of the battery.

Hereinafter, the battery power control method according to the embodiment of the present disclosure will be described in detail with reference to FIG. 3A and FIG. 3B.

The battery system based on the battery temperature sensor layout according to the embodiment of the present disclosure may include 124 cells 4. The cell 4 may have a blade-shaped structure, the cells 4 may be equally divided into two rows, and each row may include 62 cells 4. In the battery system based on the battery temperature sensor layout according to the embodiment of the present disclosure, a cooling block 5 for cooling a battery may be disposed at an upper side of all cells 4.

The battery system based on the battery temperature sensor layout according to the embodiment of the present disclosure may further include at least one first temperature sensor 1, at least one second temperature sensor 2, and at least one temperature third sensor 3. The battery system based on the battery temperature sensor layout according to the embodiment of the present disclosure may include ten first temperature sensors 1, four second temperature sensors 2, and four third temperature sensors 3.

Because the first temperature sensor 1 is disposed adjacent to an explosion-proof valve of the cell 4 and is used to sense a temperature of the cell 4, temperature abnormality of the cell 4 may be immediately identified. In the battery system based on the battery temperature sensor layout according to the embodiment of the present disclosure, each of two rows of cells 4 may include five first temperature sensors 1, three first temperature sensors 1 among the five first temperature sensors 1 may be disposed at a left side of the cell 4, and for example, the three first temperature sensors 1 may be uniformly disposed in a disposition direction of the cell 4. Two first temperature sensors 1 among the five first temperature sensors 1 may be disposed at a right side of the cell 4, and for example, the two first temperature sensors 1 may be uniformly disposed in a disposition direction of the cell 4.

Because the second temperature sensor 2 is disposed at a lower portion of the cell 4 and is used to sense a temperature of the cell 4, a minimum temperature of the cell 4 may be immediately identified during a low-temperature heating operation of the battery. Additionally, the second temperature sensor 2 may immediately determine a maximum temperature of the cell 4 during a cooling operation at a high temperature of the battery. In the battery system based on the battery temperature sensor layout according to the embodiment of the present disclosure, each of two rows of cells 4 may include two second temperature sensors 2. The two second temperature sensors 2 may be disposed at a lower right of the cell 4, and for example, the two second temperature sensors 2 may be disposed at a lower right of an outermost cell 4 in a disposition direction of the cell 4.

Because the third temperature sensor 3 is disposed at an upper portion of the cell 4 and is used to sense a temperature of the cell 4, a minimum temperature of the cell 4 may be immediately identified during a cooling operation when the battery is at a high temperature, and a maximum temperature of the cell may be immediately identified during a heating operation when the battery is at a low temperature. In the battery system based on the battery temperature sensor layout according to the embodiment of the present disclosure, each of two rows of cells 4 may include two third temperature sensors 3, and the two third temperature sensors 3 may be disposed at an upper-middle portion of the cell 4. For example, the third temperature sensor 3 may be disposed at an upper-middle portion of an outermost cell 4 in a disposition direction of the cell 4.

The battery system based on the battery temperature sensor layout according to the embodiment of the present disclosure may further include a controller. The controller may receive temperatures sensed by the first temperature sensor 1, the second temperature sensor 2, and the third temperature sensor 3, and may determine whether a thermal runaway fault, an over-temperature fault, or a low temperature fault of the battery occurs based on the temperatures sensed by the first temperature sensor 1, the second temperature sensor 2, and the third temperature sensor 3. If it is determined that the thermal runaway fault, the over-temperature fault, the low temperature fault, or another serious fault occurs in the battery, a charging voltage of the battery reaches a charging cutoff voltage, or a discharging voltage of the battery reaches a discharging cutoff voltage, the controller may set charging power or discharging power of the battery to zero. If it is determined that the thermal runaway fault does not occur, the over-temperature fault does not occur, the low temperature fault does not occur, and the other serious fault does not occur based on the temperatures sensed by the first temperature sensor 1, the second temperature sensor 2, and the third temperature sensor 3, the charging voltage of the battery does not reach the charging cutoff voltage, and the discharging voltage of the battery does not reach the discharging cutoff voltage, the controller may determine maximum charging power or maximum discharging power of the battery and may make power of the battery less than or equal to the maximum charging power or the maximum discharging power.

For example, in a step S10, the temperatures sensed by the first temperature sensor 1, the second temperature sensor 2, and the third temperature sensor 3 may be compared with each other to determine a maximum temperature and a minimum temperature sensed.

After the maximum temperature and the minimum temperature are determined, in a step S11, it may be determined whether the sensed maximum temperature exceeds a first predetermined temperature to continue for a first predetermined time. In an embodiment of the present disclosure, a normal use temperature range of the battery may be −30° C. to 60° C., the first predetermined temperature may be set to 90° C., and the first predetermined time may be 5 s. For example, when the temperatures sensed by the first temperature sensor 1, the second temperature sensor 2, and the third temperature sensor 3 are compared, a second high temperature sensed may be additionally determined as a next highest temperature. The controller may secure accuracy by determining whether the maximum temperature and the next highest temperature among the sensed temperatures exceed the first predetermined temperature to continue for the first predetermined time.

If the sensed maximum temperature exceeds the first predetermined temperature to continue for the first predetermined time, it may be determined in a step S26 that the thermal runaway fault of the battery occurs. Additionally, after it is determined that the thermal runaway fault of the battery occurs, in a step S80, charging power or discharging power of the battery may be set to 0.

If the maximum temperature does not exceed the first predetermined temperature or a state in which the maximum temperature exceeds the first predetermined temperature does not continue for the first predetermined time, in a step S12, whether the maximum temperature exceeds a second predetermined temperature to continue for a second predetermined time and whether one-third or more of a total number of the first temperature sensor, the second temperature sensor, and the third temperature sensor disconnected continues for the second predetermined time may be determined. A ratio of the number of disconnected sensors to the total number of the first temperature sensor, the second temperature sensor, and the third temperature sensor may be set according to an actual usage situation. In an embodiment of the present disclosure, the second predetermined temperature may be set to 70° C., the second predetermined time may be 30 seconds, and if the total number of the first temperature sensor, the second temperature sensor, and the third temperature sensor is 18, the number of disconnected temperature sensors may be 7.

If the maximum temperature exceeds the second predetermined temperature to continue for the second predetermined time and the one-third or more of the total number of the first temperature sensor, the second temperature sensor, and the third temperature sensor disconnected continues for the second predetermined time, it may be determined in the step S26 that the thermal runaway fault of the battery occurs. Additionally, after it is determined that the thermal runaway fault of the battery occurs, in the step S80, charging power or discharging power of the battery may be set to 0.

If the maximum temperature does not exceed the second predetermined temperature, a state in which the maximum temperature exceeds the second predetermined temperature does not continue for the second predetermined time, the one-third or more of the total number of the first temperature sensor, the second temperature sensor, and the third temperature sensor are not disconnected, or a state in which the one-third or more of the total number of the first temperature sensor, the second temperature sensor, and the third temperature sensor are disconnected does not continue for the second predetermined time, it may be determined in a step S13 whether the maximum temperature exceeds the second predetermined temperature and whether a temperature continuously rises within a third predetermined time so that a predetermined temperature difference occurs. In an embodiment of the present disclosure, the third predetermined time may be set to 60 seconds, and the predetermined temperature difference may be set to 20° C. For example, the maximum temperature may continuously rise within the third predetermined time, and the predetermined temperature difference may occur within the third predetermined time.

If the maximum temperature exceeds the second predetermined temperature and the temperature continuously rises within the third predetermined time so that the predetermined temperature difference occurs, it may be determined in the step S26 that the thermal runaway fault of the battery occurs. Additionally, after it is determined that the thermal runaway fault of the battery occurs, in the step S80, charging power or discharging power of the battery may be set to 0.

If the maximum temperature does not exceed the second predetermined temperature, the temperature does not continuously rise within the third predetermined time, or the predetermined temperature difference does not occur, it may be determined in a step S14 whether the maximum temperature is less than a third predetermined temperature. In an embodiment of the present disclosure, the third predetermined temperature may be set to 65° C.

If the maximum temperature is less than the third predetermined temperature, it may be determined in a step S15 that the thermal runaway fault of the battery does not occur.

If the maximum temperature exceeds the third predetermined temperature, it may be determined in a step S16 whether the maximum temperature exceeds the second predetermined temperature. If the maximum temperature exceeds the second predetermined temperature, after a fourth predetermined time in a step S17, in the step S13, it may be determined again whether the maximum temperature continuously rises within the third predetermined time so that a predetermined temperature difference occurs. In an embodiment of the present disclosure, the fourth predetermined time may be 1 min.

If the maximum temperature does not exceed the second predetermined temperature, it may be determined in the step S15 that the thermal runaway fault of the battery does not occur.

Additionally, if the controller determines that the thermal runaway fault of the battery does not occur, it may be determined in a step S20 whether the minimum temperature is less than a fourth predetermined temperature. In an embodiment of the present disclosure, the fourth predetermined temperature may be set to −30° C.

If the minimum temperature is less than the fourth predetermined temperature, it may be determined in a step S21 that the low temperature fault occurs. After it is determined that the low temperature fault occurs, in the step S80, charging power or discharging power of the battery may be set to 0.

If the minimum temperature is not less than the fourth predetermined temperature, it may be determined in a step S30 whether the maximum temperature exceeds a fifth predetermined temperature. In an embodiment of the present disclosure, the fifth predetermined temperature may be set to 60° C.

If the maximum temperature exceeds the fifth predetermined temperature, it may be determined in a step S31 that the over-temperature fault occurs. After it is determined that the over-temperature fault occurs, in the step S80, charging power or discharging power of the battery may be set to 0.

If the maximum temperature does not exceed the fifth predetermined temperature, it may be determined in a step S40 whether the maximum temperature exceeds a sixth predetermined temperature. In an embodiment of the present disclosure, the sixth predetermined temperature may be set to 55° C.

If the maximum temperature exceeds the sixth predetermined temperature, in a step S41, charging power of the battery may be set to 0, or the controller may determine maximum discharging power of the battery and may set power of the battery to be less than or equal to the maximum discharging power. A method of determining the maximum discharging power of the battery will be described below.

If the maximum temperature does not exceed the sixth predetermined temperature, it may be determined in a step S42 that the low temperature fault or the over-temperature fault of the battery does not occur.

If it is determined that the thermal runaway fault, the low temperature fault, and the over-temperature fault of the battery do not occur, in a step S50, it may be determined whether another serious fault of the battery occurs based on fault alarm information or a flag generated by a battery controller. If a fault that seriously affects safety of the battery and a vehicle occurs in the battery system, in the step S80, charging power or discharging power of the battery may be set to 0. If it is determined that the other serious fault does not occur in the battery, in a step S60, it may be determined whether the charging voltage of the battery reaches the charging cutoff voltage or whether the discharging voltage of the battery reaches the discharging cutoff voltage. If it is determined that the charging voltage of the battery has reached the charging cutoff voltage or the discharging voltage of the battery has reached the discharging cutoff voltage, in step S80, the charging power or discharging power of the battery may be set to 0.

If it is determined that the charging voltage of the battery does not reach the charging cutoff voltage and the discharging voltage of the battery does not reach the discharging cutoff voltage, in a step S70, maximum charging power or maximum discharging power of the battery may be determined, and power of the battery may be made less than or equal to the maximum charging power or the maximum discharging power.

As shown in FIG. 2, if the battery is discharged, the controller may inquire about a discharging power table to determine discharging power at the maximum temperature of the battery and discharging power at the minimum temperature of the battery using the maximum temperature, the minimum temperature, and an SOC of the battery that are determined, and may compare the determined discharging powers with each other to determine small discharging power as maximum discharging power of the battery.

Similarly, if the battery is charged, the controller may inquire about a charging power table to determine charging power at the maximum temperature of the battery and charging power at the minimum temperature of the battery using the maximum temperature, the minimum temperature, and an SOC of the battery that are determined, and may compare the determined charging powers with each other to determine small charging power as maximum charging power of the battery.

The battery system and the battery power control method based on the battery temperature sensor layout disclosed in the above embodiment may sense temperatures of different portions of the cell by disposing temperature sensors at different portions of the cell, and may control power of the battery by determining whether the fault of the battery occurs and a type of the fault according to the sensed temperatures so that life and safety of the battery are improved.

While this disclosure has been described in connection with what is presently considered to be practical embodiments, it should be understood that the disclosure is not limited to the disclosed embodiments, but, on the contrary, is intended to cover various modifications and equivalent arrangements included within the spirit and scope of the appended claims.

What is claimed is:

1. A battery system based on a battery temperature sensor layout, wherein a battery includes a plurality of cells and a cooling block disposed at an upper side of the cell, comprising:
at least one first temperature sensor that is disposed adjacent to an explosion-proof valve of the at least one cell and is configured to sense a temperature of the cell;
at least one second temperature sensor that is disposed at a lower portion of the at least one cell and is configured to sense a temperature of the cell;
at least one third temperature sensor that is disposed at an upper portion of the at least one cell and is configured to sense a temperature of the cell; and
a controller that is configured to receive temperatures sensed by the first temperature sensor, the second temperature sensor, and the third temperature sensor and to determine whether a thermal runaway fault, an over-temperature fault, or a low temperature fault of the battery occurs based on the temperatures sensed by the first temperature sensor, the second temperature sensor, and the third temperature sensor.

2. The battery system of claim 1, wherein the controller is configured to:
determine a maximum temperature and a minimum temperature based on the temperatures sensed by the first temperature sensor, the second temperature sensor, and the third temperature sensor, and
determine whether the thermal runaway fault, the over-temperature fault, or the low temperature fault of the battery occurs using the determined maximum and minimum temperatures.

3. The battery system of claim 2, wherein the controller is further configured to:
determine whether the maximum temperature exceeds a first predetermined temperature and maintains for a first predetermined time, and
determine that the thermal runaway fault occurs based on the maximum temperature exceeding the first predetermined temperature and maintaining for the first predetermined time.

4. The battery system of claim 3, wherein the controller is further configured to:
determine whether the maximum temperature exceeds a second predetermined temperature and maintains for a second predetermined time and whether one-third or more of a total number of the first temperature sensor, the second temperature sensor, and the third temperature sensor are disconnected and disconnected states continue for the second predetermined time based on the maximum temperature not exceeding the first predetermined temperature or a state in which the maximum temperature exceeds the first predetermined temperature not maintaining for the first predetermined time, and
determine that the thermal runaway fault occurs based on the maximum temperature exceeding the second predetermined temperature and maintaining for the second predetermined time and the one-third or more of the total number of the first temperature sensor, the second temperature sensor, and the third temperature sensor being disconnected and the disconnected states continuing for the second predetermined time, and
wherein the second predetermined temperature is less than the first predetermined temperature.

5. The battery system of claim 4, wherein the controller is further configured to:
determine whether the maximum temperature exceeds the second predetermined temperature and whether the temperatures continuously rise within a third predetermined time so that a predetermined temperature difference between the temperatures occurs based on the maximum temperature not exceeding the second predetermined temperature, a state in which the maximum temperature exceeds the second predetermined temperature not continuing for the second predetermined time, the one-third or more of the total number of the first temperature sensor, the second temperature sensor, and the third temperature sensor not being disconnected, or a state in which the one-third or more of the total number of the first temperature sensor, the second temperature sensor, and the third temperature sensor are disconnected not continuing for the second predetermined time, and
determine that the thermal runaway fault occurs based on the maximum temperature exceeding the second predetermined temperature and the temperature continuously rising within the third predetermined time so that the predetermined temperature difference between the temperatures occurs.

6. The battery system of claim 5, wherein the controller is further configured to:
determine whether the maximum temperature is less than a third predetermined temperature based on the maximum temperature not exceeding the second predetermined temperature, the temperature not continuously rising within the third predetermined time, or the predetermined temperature difference between the temperatures not occurring, and
determine that the thermal runaway fault does not occur based on the maximum temperature being less than the third predetermined temperature, and
wherein the third predetermined temperature is less than the second predetermined temperature.

7. The battery system of claim 6, wherein the controller is further configured to:
determine whether the maximum temperature exceeds the second predetermined temperature based on the maximum temperature exceeding the third predetermined temperature,
determine again whether the maximum temperature continuously rises within the third predetermined time so that the predetermined temperature difference between the temperatures occurs after a fourth predetermined time based on the maximum temperature exceeding the second predetermined temperature, and
determine that the thermal runaway fault does not occur based on the maximum temperature not exceeding the second predetermined temperature.

8. The battery system of claim 6, wherein the controller is further configured to:
determine whether the minimum temperature is less than a fourth predetermined temperature, and
determine that the low temperature fault occurs based on the minimum temperature being less than the fourth predetermined temperature.

9. The battery system of claim 8, wherein the controller is further configured to:
determine whether the maximum temperature exceeds a fifth predetermined temperature based on the minimum temperature not being less than the fourth predetermined temperature, and
determine that the over-temperature fault occurs based on the maximum temperature exceeding the fifth predetermined temperature, and
wherein the fifth predetermined temperature is greater than the fourth predetermined temperature.

10. The battery system of claim 9, wherein the controller is further configured to:
determine whether the maximum temperature exceeds a sixth predetermined temperature based on the maximum temperature not exceeding the fifth predetermined temperature, and
set charging power of the battery to 0 or determine maximum discharging power of the battery and set power of the battery to be less than or equal to the maximum discharging power based on the maximum temperature exceeding the sixth predetermined temperature, and
wherein the sixth predetermined temperature is less than the fifth predetermined temperature.

11. A power control method of a battery that includes a plurality of cells and a cooling block disposed at an upper side of the cell, comprising:
sensing temperatures of the cell using at least one first temperature sensor, at least one second temperature sensor, and at least one third temperature sensor; and
determining whether a thermal runaway fault, an over-temperature fault, or a low temperature fault of the battery occurs using the temperatures sensed by the first temperature sensor, the second temperature sensor, and the third temperature sensor,
wherein the at least one first temperature sensor is disposed adjacent to an explosion-proof valve of the at least one cell, the at least one second temperature sensor is disposed at a lower portion of the at least one cell, and the at least one third temperature sensor is disposed at an upper portion of the at least one cell.

12. The power control method of claim 11, further comprising:
determining a maximum temperature and a minimum temperature based on the temperatures sensed by the first temperature sensor, the second temperature sensor, and the third temperature sensor; and
determining whether the thermal runaway fault, the over-temperature fault, or the low temperature fault of the battery occurs using the determined maximum and minimum temperatures.

13. The power control method of claim 12, further comprising:
determining whether the maximum temperature exceeds a first predetermined temperature and maintains for a first predetermined time; and
determining that the thermal runaway fault occurs based on the maximum temperature exceeding the first predetermined temperature and maintaining for the first predetermined time.

14. The power control method of claim 13, further comprising:
determining whether the maximum temperature exceeds a second predetermined temperature and maintains for a second predetermined time and whether one-third or more of a total number of the first temperature sensor, the second temperature sensor, and the third temperature sensor are disconnected and disconnected states continue for the second predetermined time based on the maximum temperature not exceeding the first predetermined temperature or a state in which the maximum temperature exceeds the first predetermined temperature not maintaining for the first predetermined time; and
determining that the thermal runaway fault occurs based on the maximum temperature exceeding the second predetermined temperature and maintaining for the second predetermined time and the one-third or more of the total number of the first temperature sensor, the second temperature sensor, and the third temperature sensor being disconnected and the disconnected states continuing for the second predetermined time,
wherein the second predetermined temperature is less than the first predetermined temperature.

15. The power control method of claim 14, further comprising:
determining whether the maximum temperature exceeds the second predetermined temperature and whether the temperatures continuously rise within a third predetermined time so that a predetermined temperature difference between the temperatures occurs based on the maximum temperature not exceeding the second predetermined temperature, a state in which the maximum temperature exceeds the second predetermined temperature not continuing for the second predetermined time, the one-third or more of the total number of the first temperature sensor, the second temperature sensor, and the third temperature sensor not being disconnected, or a state in which the one-third or more of the total number of the first temperature sensor, the second temperature sensor, and the third temperature sensor are disconnected not continuing for the second predetermined time; and
determining that the thermal runaway fault occurs based on the maximum temperature exceeding the second predetermined temperature and the temperature continuously rising within the third predetermined time so that the predetermined temperature difference between the temperatures occurs.

16. The power control method of claim 15, further comprising:
determining whether the maximum temperature is less than a third predetermined temperature based on the maximum temperature not exceeding the second predetermined temperature, the temperature not continuously rising within the third predetermined time, or the predetermined temperature difference between the temperatures not occurring; and
determining that the thermal runaway fault does not occur based on the maximum temperature being less than the third predetermined temperature,
wherein the third predetermined temperature is less than the second predetermined temperature.

17. The power control method of claim 16, further comprising:
determining whether the maximum temperature exceeds the second predetermined temperature based on the maximum temperature exceeding the third predetermined temperature;
determining again whether the maximum temperature continuously rises within the third predetermined time so that the predetermined temperature difference between the temperatures occurs after a fourth predetermined time based on the maximum temperature exceeding the second predetermined temperature; and
determining that the thermal runaway fault does not occur based on the maximum temperature not exceeding the second predetermined temperature.

18. The power control method of claim 16, further comprising:
determining whether the minimum temperature is less than a fourth predetermined temperature; and
determining that the low temperature fault occurs based on the minimum temperature being less than the fourth predetermined temperature.

19. The power control method of claim 18, further comprising:
determining whether the maximum temperature exceeds a fifth predetermined temperature based on the minimum temperature not being less than the fourth predetermined temperature; and
determining that the over-temperature fault occurs based on the maximum temperature exceeding the fifth predetermined temperature,
wherein the fifth predetermined temperature is greater than the fourth predetermined temperature.

20. The power control method of claim 19, further comprising:
determining whether the maximum temperature exceeds a sixth predetermined temperature based on the maximum temperature not exceeding the fifth predetermined temperature; and
setting charging power of the battery to 0 or determining maximum discharging power of the battery and setting power of the battery to be less than or equal to the maximum discharging power based on the maximum temperature exceeding the sixth predetermined temperature,
wherein the sixth predetermined temperature is less than the fifth predetermined temperature.
